(19) United States
(12) Patent Application Publication
(10) Pub. No.: US 2025/0033737 A1
(43) Pub. Date: Jan. 30, 2025

(54) Method for Controlling a Gear Shifting Means of a Bicycle

(71) Applicant: Robert Bosch GmbH, Stuttgart (DE)

(72) Inventor: Juergen Stegmaier, Wannweil (DE)

(21) Appl. No.: 18/778,997

(22) Filed: Jul. 21, 2024

(30) Foreign Application Priority Data
Jul. 24, 2023 (DE) 10 2023 207 004.9

(51) Int. Cl. B62M 6/50

(52) U.S. Cl. CPC B62M 6/50

(57) ABSTRACT

A method for controlling a gear shifting mechanism of a bicycle includes (i) ascertaining a reference shifting point, (ii) ascertaining the current travel situation of the bicycle, (iii) determining a shifting hysteresis based on the current travel situation ascertained, and (iv) ascertaining a target shifting point by adjusting the reference shifting point by way of the shifting hysteresis determined.

This application claims priority under 35 U.S.C. § 119 to patent application no. DE 10 2023 207 004.9, filed on Jul. 24, 2023 in Germany, the disclosure of which is incorporated herein by reference in its entirety.

### BACKGROUND

The present disclosure relates to a method for controlling a gear shifting means of a bicycle, a shifting system of a bicycle, and a bicycle.

Shifting systems for bicycles designed to be electronically operable are known. The ability to automatically operate of a gear shifting means or mechanism is provided thereby. For example, certain shifting thresholds are provided to trigger such automatic gear change operation. Such shifting thresholds can be stored in the form of tables in a memory of a control unit of the shifting system. With automatic shifting for bicycles, there is often a conflict between providing an optimal gear ratio for as high a pedaling comfort as possible for the rider of the bicycle and avoiding unnecessarily frequent gear changes.

### SUMMARY

In contrast, the method according to the disclosure having the features of set forth herein offers the advantage that automatic gear shifting of a bicycle shifting mechanism can be achieved in a simple manner, and a particularly high level of pedal comfort can reliably be provided for a rider of the bicycle. According to the present disclosure, this is achieved by a method for controlling a gear shifting means or mechanism of a bicycle, said method comprising the following steps:
ascertaining a reference shifting point,
ascertaining the current travel situation of the bicycle,
ascertaining a shifting hysteresis based on the current travel situation ascertained, and
ascertaining a target shifting point by adjusting the reference shifting point by means of the shifting hysteresis determined.

In other words, a characteristic reference shifting threshold in the form of the reference shifting point is ascertained during the method, and this threshold is adaptively adjusted using a (in particular variable) shifting hysteresis in order to ascertain an actual shifting threshold in the form of the target shifting point.

A plurality of possible travel situations can be ascertained as the travel situation and be used for changing the shifting hysteresis. For example, the recognition of a slope, or also the recognition of a predetermined mode of operation by a bicycle rider, can be ascertained as a travel situation, and the shifting hysteresis can be adjusted accordingly.

Shifting hysteresis is in particular considered to be a certain amount of change by which the reference shifting point is moved towards the target shifting point. For example, the shifting hysteresis can be considered to be a pedaling cadence amount. Alternatively, the shifting hysteresis can be defined by a further physical variable, in particular a variable, based on which the reference shifting point is defined.

Preferably, the shifting hysteresis can be determined as a certain constant value by which the reference shifting point is, e.g., moved towards the target shifting point. Alternatively preferably, the shifting hysteresis can be determined as a particular percentage deviation with respect to the reference shifting point.

Preferably, in a gear shifting means or mechanism comprising a plurality of different gear steps, i.e. a plurality of different gear ratios, a separate reference shifting point is ascertained for each gear step. Preferably, the reference pedaling cadence is identical for all of the gear steps. Alternatively, a different reference pedaling cadence can also be defined for different gear steps.

Therefore, the method provides the advantage of an optimal shifting strategy being provided by adjusting an adaptive shifting hysteresis as a function of the current travel situation of the bicycle. A desired individual pedaling cadence of the bicycle rider can, e.g., be used as the reference pedaling cadence. As a result, the method can, e.g., be used to optimally regulate the shifting strategy to a specific pedaling cadence, for example, and the number of gear changes can be reduced by adaptive adjustment of the shifting hysteresis. In particular, by adaptively adjusting the shifting hysteresis, as a result of extremely precise regulation, an optimal predetermined characteristic value and/or an extremely low number of gear changes can be achieved. In particular, the method can therefore enable particularly efficient and comfortable operation of the bicycle.

Preferred embodiments of the disclosure are also set forth below.

Preferably, the reference shifting point is ascertained such that, given a gear shift at the reference shifting point, a change in pedaling cadence caused by such gear shift is symmetrical to a reference pedaling cadence. In other words, a characteristic shifting threshold in the form of the reference shifting point is ascertained. When a shifting operation, i.e. a gear shift, in particular to an immediately adjacent gear, is performed at precisely this reference shifting point, such shift causes a certain change in pedaling cadence. Preferably, based on the previously known mechanical properties of the gear shift, and preferably additionally the drive system of the bicycle, the reference shifting point is automatically ascertained such that the corresponding change in pedaling cadence at that reference shifting point is symmetrical to a reference pedaling cadence. In particular, the amount of difference between the respective pedaling cadence before and after the gear change is considered to be a change in pedaling cadence. In particular, a theoretical change in the pedaling cadence is considered to be a pedaling change in pedaling cadence, which results in the case of pedal operation before, during and after the gear shift, in particular under tension from the bicycle's drive system. Such a change in pedaling cadence is precisely defined, for example, on the basis of the mechanical relationships of the shifting system and the entire drive train of the bicycle. In other words, the reference shifting point is defined such that, for example, when upshifting to a greater gear ratio, a pedaling cadence immediately prior to the gear shift is greater than the reference pedaling cadence by a predetermined amount. At the same time, the pedaling cadence immediately after the gear change is less than the reference pedaling cadence by the same predetermined amount. For example, when downshifting to a smaller gear ratio, the change in pedaling cadence is precisely reversed in a corresponding manner.

The reference pedaling cadence is preferably a predefined, constant value. Alternatively, preferably, the reference pedaling cadence is a constant value that can be specified by a user. Further alternatively, the reference cadence is preferably designed to be variable, and can in particular can be established as a function of one or more of the following parameters: current gear step, travel parameters of the bicycle, environmental parameters. In particular, these parameters can be sensed in a sensor-based manner and/or entered using an input device. For example, a speed and/or a slope and/or an acceleration of the bicycle can be used as travel parameters. For example, the current slope on which the bicycle is traveling and/or road parameters, such as curves to be taken, or a path to be traveled can be used as environmental parameters. As a result, a particularly flexible and precise adjustment between the shifting strategy and the travel operation of the bicycle and/or to user-specific preferences can be undertaken.

Particularly preferably, in a first travel situation, a reduction of the shifting hysteresis is performed in order to reduce, in particular to minimize, a deviation of an actual pedaling cadence from the reference pedaling cadence. In particular, the actual pedaling cadence is considered to be an actual current cadence, at which the bicycle rider operates the pedals. In other words, in the first travel situation, the reference pedaling cadence is controlled as precisely as possible by means of a small hysteresis. Alternatively or additionally, an increase in the shifting hysteresis in a second travel situation is preferably performed to reduce, in particular to minimize, the number of gear changes, particularly during the duration of the second travel situation. In other words, in the second travel situation, fewer shifts are made due to a large hysteresis.

Preferably, one target upshifting point and one target downshifting point are ascertained for each reference shifting point, respectively, by means of the shifting hysteresis. In particular, the reference shifting point is for this purpose moved in opposite directions by means of the shifting hysteresis. Preferably, a shifting point is considered to be a target upshifting point, at which shifting occurs to a larger gear step, i.e., to a larger gear ratio. Furthermore, preferably, a shifting point is considered to be a target downshifting point, at which shifting occurs to a smaller gear step, i.e., to a smaller gear ratio. An automatic shifting method can thereby be provided particularly reliably and efficiently, which can avoid undesirable frequent gear changes.

Preferably, the target downshifting point is defined at lower speeds, in particular in relation to operation of the bicycle, as compared to the reference shifting point. Alternatively or additionally, the target upshifting point is preferably defined at higher speeds, in particular in relation to operation of the bicycle, as compared to the reference shifting point. In other words, when the speed is, e.g., reduced and the pedaling cadence is reduced as a result when the reference pedaling cadence is reached, shifting does not occur immediately, but only after a further reduction and the target downshifting point is reached. Preferably, the upshift is performed in an similar manner when the speed is increased. As a result, a high degree of riding comfort during operation of the bicycle can be provided at optimal efficiency.

Further preferably, the shifting hysteresis is equal to the respective target downshifting point and target upshifting point for each reference switching point. In other words, the target downshifting point and the target upshifting point are arranged symmetrically with respect to the reference shifting point by the same shifting hysteresis. Alternatively, the shifting hysteresis is different from the respective target downshifting point and target upshifting point for each reference shifting point. In other words, by means of various shifting hysteresis values, the target downshifting point and the target upshifting point are arranged asymmetrically to the reference shifting point.

Particularly preferably, the shifting hysteresis is variably adjusted as a function of one or more of the following parameters: current gear step, travel parameters of the bicycle, environmental parameters, user-specific input. In particular, these parameters can be sensed in a sensor-based manner and/or entered using an input device. For example, a speed and/or a slope and/or an acceleration of the bicycle can be used as travel parameters. For example, the current slope on which the bicycle is traveling and/or road parameters, such as curves to be taken, or a path to be traveled can be used as environmental parameters. As a result, the shifting strategy can be particularly accurately adapted to the bicycle's operation.

Preferably, the method further comprises the following steps: ascertaining a constant rate of travel as the current travel situation and reducing the shifting hysteresis in response to the constant rate of travel ascertained. Preferably, the constant rate of travel corresponds to the first travel situation. Preferably, a constant rate of travel is considered to be operation of the bicycle at a substantially constant speed over at least a predetermined period of time. For example, the operation of the bicycle is considered to be a constant rate of travel if, for example, over a period of at least 10 seconds, in particular at least 30 seconds, there is a maximum fluctuation of the bicycle speed of 15%, preferably 10%, in particular 5%. Preferably, the shifting hysteresis is determined in response to the ascertainment of the constant rate of travel such that the shifting hysteresis is a percent deviation with respect to the reference shifting point of a maximum of 10%, preferably a maximum of 7%, in particular a maximum of 5%. Therefore, during a stationary journey at a substantially constant rate of speed over a longer period of time, a rider's desired pedaling cadence (which can, e.g., correspond to the reference pedaling cadence) can be adjusted as accurately as possible.

Further preferably, the method comprises the following steps: ascertaining a pedaling pause as the current travel situation and increasing the shifting hysteresis in response to the ascertainment of the pedaling pause. Preferably, the pedaling pause corresponds to the second travel situation. Particularly preferably, increasing the shifting hysteresis in response to ascertaining the pedaling pause can be performed for the target downshifting point only, preferably maintaining the shifting hysteresis for the target upshifting point. Preferably, a pause in pedal actuation by the rider for at least a predetermined period, e.g. at least two seconds, preferably a maximum of ten seconds, is considered to be a pedaling pause. Alternatively, a pedaling pause can be regarded as a state when the bicycle rider is not exerting a pedal torque on the bicycle's drive train, with it still, e.g., being possible for the pedals to continue rotating freely without force being transferred to the drive train. Preferably, the shifting hysteresis is determined in response to the ascertainment of the pedaling pause such that the shifting hysteresis is a percent deviation with respect to the reference shifting point of at least 10%, preferably at least 13%, in particular at least 15%. Such a pedaling pause can, e.g., occur while riding around a curve. The (e.g., short-term) increase in the shifting hysteresis does not immediately effect downshifting to a smaller gear during the pedaling pause. As a result, the previous gear change is, e.g., prevented from having to be immediately resumed after the rider resumes pedaling. In other words, unwanted back-and-forth shifting can be avoided.

Further preferably, the method comprises the following steps: ascertaining an ascent as the current travel situation and increasing the shifting hysteresis in response to the ascertainment of the ascent. Preferably, the ascent corresponds to the second travel situation. Preferably, an ascent is considered to be operation of the bicycle on a slope going uphill, preferably whereby the slope corresponds to at least a slope of 5% with respect to the horizontal plane. Preferably, the shifting hysteresis is determined in response to the ascertainment of the ascent such that the shifting hysteresis is a percent deviation with respect to the reference shifting point of at least 10%, preferably at least 13%, in particular at least 15%. Such an increase in the shifting hysteresis during an ascent is particularly advantageous with an electric bicycle. For example, if the speed of the electric bicycle decreases due to low engine power, a smaller gear is selected. In particular, in the case of an electric bicycle comprising a motor arranged in the crankshaft region, the shift in gear causes the engine speed to increase again at the smaller gear, which, for example, can again provide more engine power and can accelerate the electric bicycle and, as a result, it could be switched back into a larger gear, for example. By increasing the shifting hysteresis, an undesirable frequent back-and-forth shifting is thus effectively avoided in a simple way.

The method preferably comprises the following steps: ascertaining acceleration as the current travel situation and reducing the shifting hysteresis for the target upshifting point, in particular to the value of zero. Preferably, the shifting hysteresis for the target downshifting point is kept constant or, alternatively, preferably increased. Preferably, the acceleration corresponds, in particular at least in part, to the first travel situation. Preferably, acceleration is considered to be operation of the bicycle with positive acceleration, i.e., at significantly increasing speed. In particular, if multiple gear changes occur consecutively during the acceleration, then an optimal pedaling cadence can thereby be provided in order to enable particularly efficient acceleration of the bicycle. For example, due to the small shifting hysteresis, preferably of zero, an immediate targeted upshift can be enabled for the target upshifting point, which can, e.g., prevent the pedals from being operated more quickly during the acceleration process than would be optimal.

The method further preferably comprises the following step: ascertaining a shifting speed at the target shifting point based on a gear ratio of the bicycle. In particular, the shifting speed is considered to be the speed at which the bicycle is traveling at the target shifting point, e.g. theoretically. This shifting speed is in particular specified by the mechanical relationship between, in particular, the theoretical pedaling cadence at the target shifting point and the gear ratio of the bicycle, in particular as a function of the corresponding gear step. In this case, an overall gear ratio of the bicycle is, e.g., considered between the cranks and a rear wheel. A particularly simple ascertainment of the advantageous shifting points can be performed as a result.

Preferably, the shifting speed can, e.g., be ascertained at any time, even at a standstill and/or prior to initial start-up of the bicycle. The shifting speed can, e.g., be stored as a characteristic value for the shifting system.

Further preferably, the method comprises the following steps: sensing a speed, in particular the current speed of the bicycle, and actuating a gear shift when the sensed speed reaches the shifting speed. In other words, the initiation of the shifting operations occurs in the method as a function of the sensed speed, at which the bicycle is traveling. As a result, in addition to a particularly simple and inexpensive implementation of the method, a particularly advantageous shifting strategy can also be provided, for example, because it can be independent of the current pedaling cadence at which the rider is pedaling the bicycle. For example, when going downhill, if pedaling is not occurring, the optimal shifting point can be determined as a function of the speed, such that, for example, the optimal gear step can be engaged when pedaling is restarted.

The method preferably comprises the following steps: ascertaining a shifting pedaling cadence at the target shifting point, sensing a pedaling cadence, in particular the pedaling cadence at the current moment, and actuating a gear shift when the sensed pedaling cadence reaches the shifting pedaling cadence. In other words, the initiation of the shift operations is dependent on the sensed cadence at which the rider is pedaling the bicycle. As a result, particularly precise control of the switching operations can be provided for optimally regulating an advantageous pedaling cadence.

Particularly preferably, the gear shifting means or mechanism of the bicycle comprises a plurality of different gear steps. A separate reference shifting point is in this case ascertained for each gear shift between different gear steps. In other words, the shifting points are ascertained individually for each of the gear steps. As a result, the shifting strategy can be adjusted particularly precisely to provide optimal riding comfort for the rider of the bicycle.

Furthermore, the disclosure leads to shifting system for a bicycle, preferably an electric bicycle comprising a gear shifting means and a control unit. The control unit is in this case configured to operate the gear shifting means and to perform the described method. Preferably, the gear shifting means or mechanism comprises a derailleur configured to move a bicycle chain between sprockets of different sizes to thereby alter a gear ratio. Alternatively or additionally, preferably, the gear shifting means or mechanism can comprise a gearbox system. Particularly preferably, the gear shifting means or mechanism comprises an electronic actuation device, the control unit in particular being configured to operate the electronic actuation device of the gear shifting means or mechanism.

The disclosure further relates to a bicycle, preferably an electric bicycle comprising the shifting system described.

### BRIEF DESCRIPTION OF THE DRAWINGS

The disclosure will be described hereinafter based on exemplary embodiments in connection with the drawings. In the drawings, functionally identical components are respectively denoted by identical reference signs. Shown are:

FIG. 1 a simplified schematic view of a bicycle in which a method for controlling a gear shifting means or mechanism of the bicycle is shown, according to a first exemplary embodiment of the disclosure,

FIG. 2 an extremely simplified schematic view of the steps in the method of the first exemplary embodiment,

FIG. 3 a simplified schematic view of shifting operations when performing the method of the first exemplary embodiment,

FIG. 4 a simplified schematic view of shifting operations when performing the method according to a second exemplary embodiment of the disclosure,

FIG. 5 an extremely simplified schematic view of the steps of a method according to a third exemplary embodiment of the disclosure,

FIG. 6 a simplified schematic view of shifting operations when performing the method of the third exemplary embodiment, and

FIG. 7 a simplified schematic view of shifting operations when performing the method according to a fourth exemplary embodiment of the disclosure.

### DETAILED DESCRIPTION

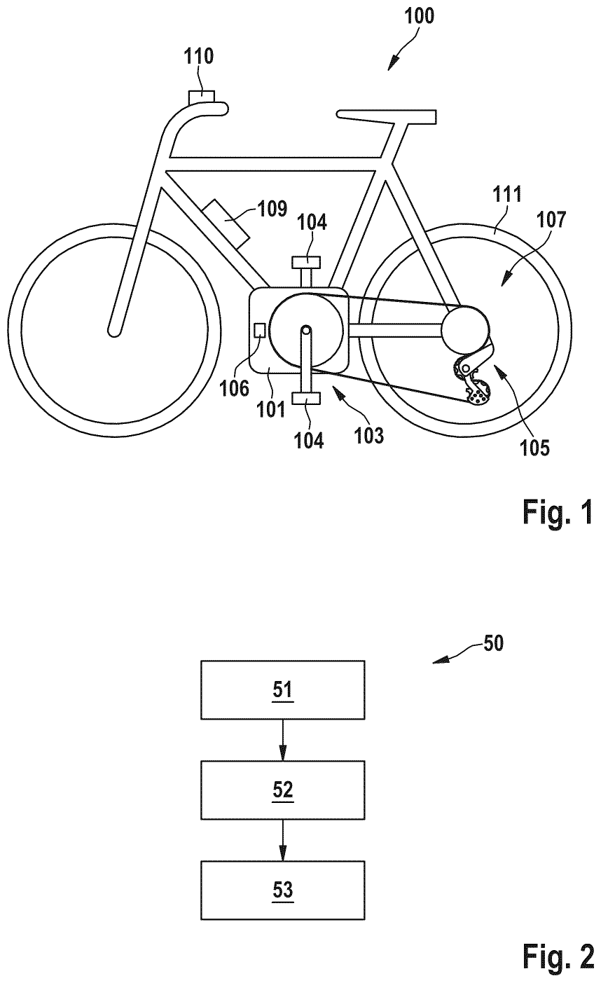

FIG. 1 shows a simplified schematic view of a bicycle 100 comprising a shifting system 107, which comprises a gear shifting means or mechanism 105 and a control unit 106. The gear shifting mechanism 105 is a derailleur including a front derailleur and a plurality of differently sized sprockets at least on a rear hub of the bicycle 100.

The gear shifting mechanism 105 comprises an electronic actuation device that, in response to receiving electronic actuation signals, causes a shift in gear, i.e., a change in the gear ratio of the drivetrain of the bicycle 100. The electronic actuation signals can be generated by the control unit 106. In particular, this can cause automatic shifting of the bicycle 100.

The bicycle 100 is an electric bicycle which comprises a drive unit 101, in particular comprising an electric motor. The control unit 106 is preferably integrated into the drive unit 101. The drive unit 101 can be supplied with electrical energy using an electrical energy storage mechanism 109 of the bicycle 100. The drive unit 101 can in this case support the pedal force generated by the muscle power of a rider of the bicycle 100 with motor torque generated by an electric motor.

The control unit 6 is configured to perform a method 50 of, in particular, automatically controlling the gear shifting mechanism 105 of the bicycle 100. The method steps of the method 50 are shown schematically in a highly simplified form in FIG. 2. Details of the shifting processes will be described in detail hereinafter. First, a general, highly simplified description of the method 50 will be provided.

In step 51 of the method 50, an ascertainment of a reference shifting point 1 is performed and, based on this, a target upshifting point 31 and a target downshifting point 32 are ascertained.

At the target upshifting point 31, preferably as the speed 22 of the bicycle 100 increases, the next higher gear step is selected. At the target downshifting point 32, preferably at a decreasing speed 22 of the bicycle 100, the next lower gear step is selected.

Also in step 51, for each target upshifting point 31 and target downshifting point 32, a shifting speed 30 can be ascertained at which the corresponding shifting point is located.

In step 52 of the method 50, sensing the current speed 22 of the bicycle 100 is performed. In step 53, the actuation of a gear change is performed when the sensed current speed 22 reaches one of the shifting speeds 30.

A more detailed description of the shifting points is provided hereinafter. The first exemplary embodiment of the method 50 according to FIGS. 1 to 3 shows a particularly simple design variant of the method 50. The method 50 according to the second to fourth exemplary embodiments exhibits further variations.

The shifting points and gear changes described hereinafter are described by way of example based on a gear change between the two highest gear steps, i.e., between the two largest gear ratios. Preferably, the process described applies in a similar manner to all of the other gear steps of the gear shifting mechanism 105.

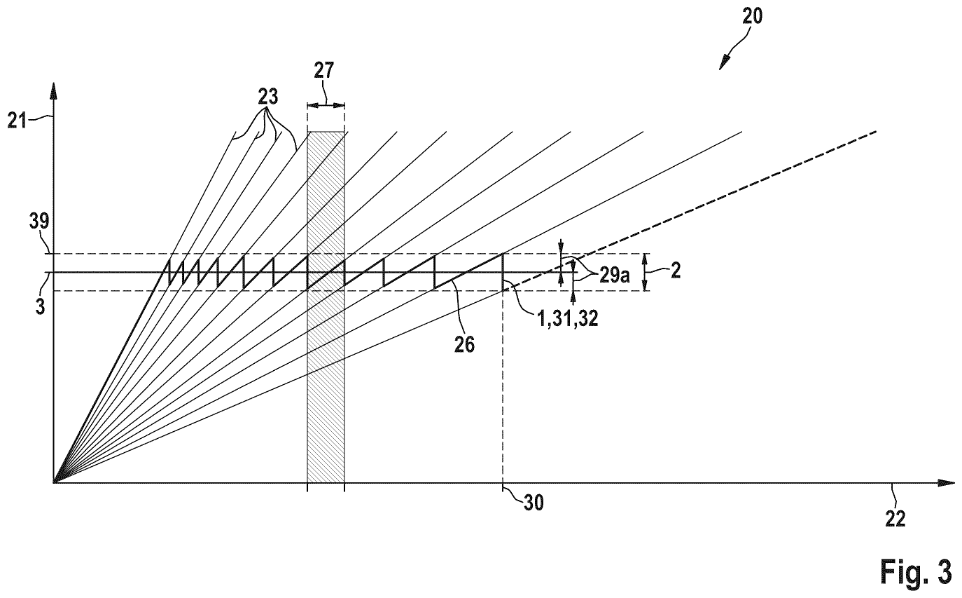

FIG. 3 shows a simplified schematic view of shifting operations when performing the method 50 of the first exemplary embodiment. FIG. 3 shows a so-called unfolding diagram 20 of the drive system of the bicycle 100. Depicted in the unfolding diagram 20 is a connection between a pedaling cadence 21 and a speed 22 for each of the gear steps of the gear shifting mechanism 105. The straight lines 23 represent the different gear steps of the gear shifting mechanism 105. These straight lines 23 are rigidly defined by the respective mechanical properties of the drive system of the bicycle 100, in particular a mechanical transmission path between the pedals 104 and the rear wheel 111 of the bicycle 100. In particular, the respective slopes of the straight lines 23 are dependent on the respective gear ratio of each gear step.

The straight lines 23 with lower slopes (i.e., towards the bottom right in the unfolding diagram 20) thereby illustrate higher gears with larger gear ratios.

In the method 50, a reference pedaling cadence 3 is defined, which is, for example, a specified constant value. For example, the reference pedaling cadence 3 can be specified by the rider of the bicycle 100.

In particular, when operating the bicycle 100, each operating point of the shifting system 107 is located on an operating line 26 as labeled in FIG. 3. The operating line 26 is always on one of the straight lines 23, and when there is a gear change, there is a vertical jump to the adjacent straight line 23 as shown in FIG. 3.

In the first exemplary embodiment, a reference shifting point 1 is ascertained such that, given a gear change performed at the reference shifting point 1, a change in pedaling cadence 2 caused by this shift is symmetrical to the reference pedaling cadence 3. In the unfolding diagram 20, the change in pedaling cadence 2 corresponds to an amount of a cadence difference, i.e. a vertical distance, between the current straight line 23 and the adjacent straight line 23 that is jumped to when the gear is changed.

In other words, the reference shifting point 1 is selected such that exactly at the reference shifting point 1 a partial amount 29a between the reference pedaling cadence 3 and the pedaling cadence 21 is the same in the gear step before and after the gear change.

In the first exemplary embodiment, the reference shifting point 1 thus ascertained also corresponds to a target upshifting point 31 and a target downshifting point 32, at which the upshift or downshift is actually initiated.

By means of the respectively defined reference shifting points 1, and since they also correspond to the actual target shifting points in the first exemplary embodiment, a speed range 27 for each gear step can be read from the unfolding diagram 20 with the correspondingly established operating line 26 as the area between two adjacent vertical changes in pedaling cadences, as in FIG. 3, shown for the eighth gear by way of example.

In the method 50, a shifting speed 30 is also ascertained for each target shifting point 31, 32 and, e.g., stored. In the operation of method 50, the actuation of the gear shifting mechanism is, preferably exclusively, dependent on the speed. In other words, when the current speed of the bicycle 100 increases and the shifting speed 30 is reached for one of the gear levels, a shift to the next higher gear is actuated. Similarly, when the current speed of the bicycle 100 drops and the shifting speed 30 is reached for one of the gear steps, a shift to the next lower gear is actuated.

Preferably, the determination of all shifting points 1, 31, 32 can be performed once, e.g. prior to the operation of the bicycle 100, by way of the control unit 106. Preferably, the respective shifting speeds 30 can be stored for all of the shifting points 1, 31, 32.

It is particularly advantageous if all gear changes are, in particular exclusively, actuated based on the current gear step and the shifting speeds 30 during operation of the bicycle 100. A particularly simple and reliable choice of gear steps in any travel situation can thus be enabled in order to enable efficient and comfortable operation of the bicycle 100.

In an alternative embodiment, the actuation of the gear changes can be based on an ascertained shift pedaling cadence 39 at the target shifting point 31, 32 and a detection of the current pedaling cadence of the bicycle 100.

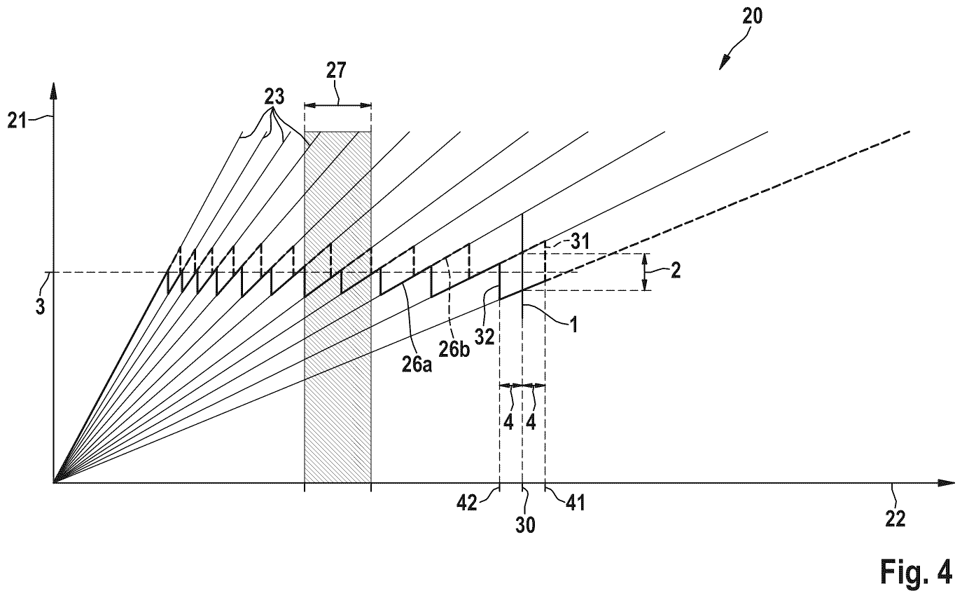

FIG. 4 shows a simplified schematic view of shifting operations when performing a method 50 according to a second exemplary embodiment of the disclosure. The second exemplary embodiment substantially corresponds to the first exemplary embodiment in FIGS. 1 to 3, with the difference that a shifting hysteresis 4 is additionally provided to determine the actual target shifting points 31, 32.

In detail, a separate target upshifting point 31 and a separate target downshifting point 32 are defined for each reference shifting point 1 in the second exemplary embodiment shown in FIG. 4. The target upshifting point 31 is in this case defined by the reference shifting point 1 being moved by the shifting hysteresis 4 towards higher speeds 22. The target downshifting point 32 is defined by the reference shifting point 1 being moved by the shifting hysteresis 4 towards lower speeds 22. Therefore, the upshift at increasing speed 22 will not occur until later, at higher speeds 22, and the downshift at decreasing speed 22 will not occur until later, at lower speeds, in each case in comparison to the reference shifting point 1. Therefore, an upshifting speed 41 also results for the target upshifting point 31, which is different from a downshifting speed 42 of the target downshifting point 32.

Therefore, in the case of, e.g., more frequent speed changes close to the reference shifting point 1, it is significantly less likely to initiate a shift. In particular, frequent undesirable back-and-forth shifting can therefore be avoided.

The shifting hysteresis 4 is defined in the second embodiment as a predefined constant percent deviation with respect to the reference switching point 1. In detail, the shifting hysteresis 4 corresponds to 5% of the speed value of the reference shifting point 1.

As seen in FIG. 4, the shifting hysteresis 4 causes a wider speed range 27 for the individual gear steps, whereby these speed ranges 27 partially overlap due to the shifting hysteresis 4 (not shown).

In the exemplary embodiment shown in FIG. 4, the shifting hysteresis 4 is designed symmetrically with respect to the reference shifting point 1. In an alternative embodiment, asymmetric shifting hysteresis 4 can also be provided. In other words, a different shifting hysteresis 4 is used for each reference shifting point 1 when ascertaining the corresponding target upshifting point 31 than when ascertaining the corresponding target downshifting point 32.

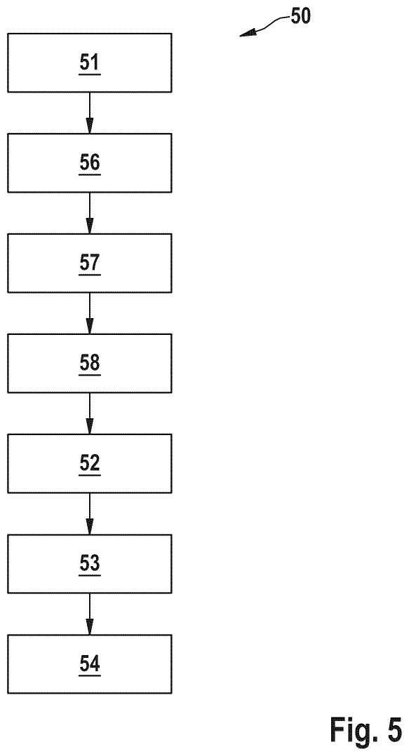

FIG. 5 shows a simplified schematic view of steps of a method 50 according to a third exemplary embodiment of the disclosure. The third exemplary embodiment substantially corresponds to the second exemplary embodiment of FIG. 4, with the difference that the shifting hysteresis 4 is designed to be adaptable to the current travel operation of the bicycle 100.

To this end, after step 51 of ascertaining reference shifting point 1 and prior to step 52, the method 50 comprises additional steps 56 to 58. In step 56, the ascertainment of the current travel situation of the bicycle 100 is performed. Preferably, the current travel situation is sensed and recognized using a sensor 110 of the bicycle 100. Based on the travel situation thus ascertained, the current shifting hysteresis 4 is subsequently adaptively adjusted in step 57. In step 58, based on the adjusted shifting hysteresis 4, the target upshifting point 31 and the target downshifting points 32 are ascertained.

The adaptive adjustment of the shifting hysteresis 4 can be performed on the basis of a variety of characteristic travel situations. It is in this case preferable to determine, based on the travel situation recognized, whether either optimal control over the reference pedaling cadence 3 or alternatively, minimizing the number of shift changes is to be prioritized. In the first case, i.e. a preferred minimization of a deviation of an actual cadence from the reference pedaling cadence 3, in particular a low shifting hysteresis 4, for example of a maximum of 10%, is set. This corresponds to, e.g., the unfolding diagram 20 in FIG. 4. In the second case, i.e. a preferred minimization of the number of shifts, in particular a high shifting hysteresis 4, for example more than 10%, is set.

In the method 20, predefined travel situations can be recognized, and predefined shifting hysteresis values 4 can be set in response thereto. For example, as previously mentioned, using the method 50 according to FIG. 5, the unfolding diagram 20 in FIG. 4 can be obtained by the adaptive adjustment of the shifting hysteresis 4 when a constant travel is ascertained as the current travel situation. Constant travel can, e.g., be recognized upon recognition of a substantially constant speed 22. The shifting hysteresis 4 is in this case reduced to the comparatively low value of 5% in order to be able to precisely control the reference pedaling cadence 3.

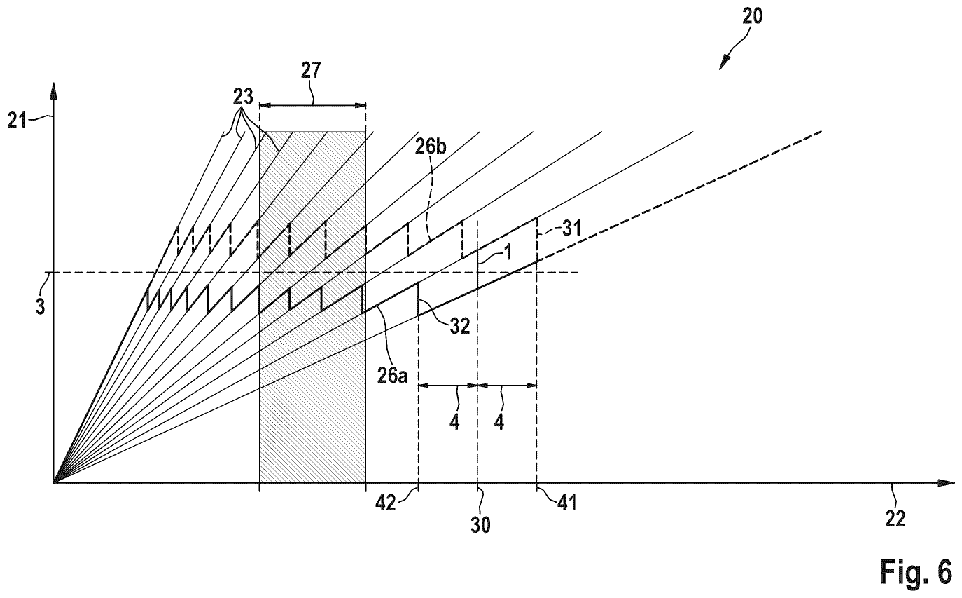

In addition, in the method 50 in FIG. 5, a determination of a pedaling pause as a current travel situation and/or a determination of an ascent as a current travel situation can be made and in response thereto, an increase in the shifting hysteresis 4 to, for example, at least 15% can be performed. A corresponding unfolding diagram 20 is shown in FIG. 6. As seen in FIG. 6, this results in an even wider speed range 27 for a single gear, and thus also a significantly greater overlap of the individual gears. As a result, a total number of shifts can be reduced as the bicycle 100 travels, which advantageously affects riding comfort for the rider in these travel situations.

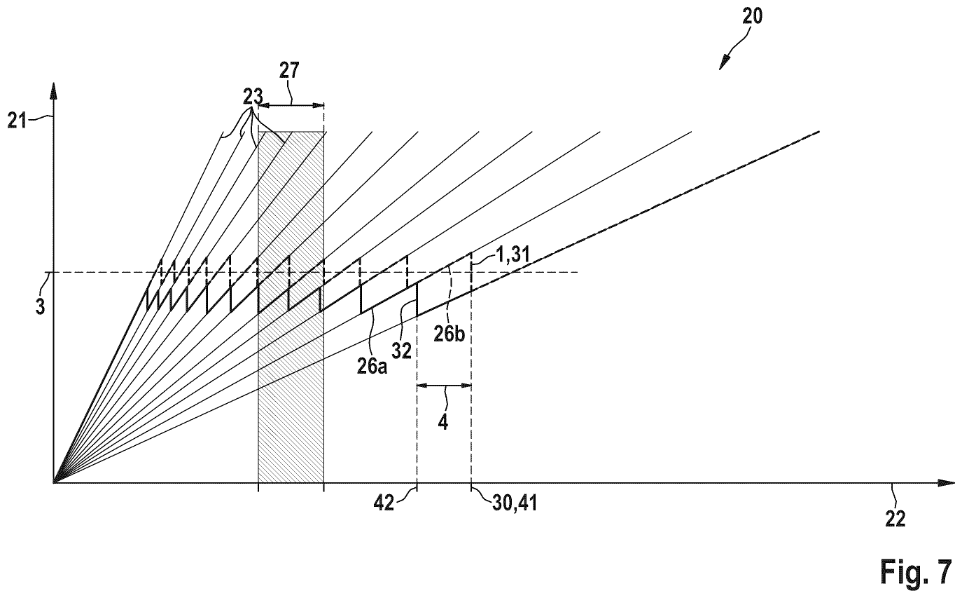

FIG. 7 shows a simplified schematic view of shifting operations when performing a method 50 according to a fourth exemplary embodiment of the disclosure. The fourth exemplary embodiment substantially corresponds to the third exemplary embodiment of FIGS. 5 and 6 and can, in particular, be considered a further development of the method 50 of the third exemplary embodiment by way of a further additional travel situation. In the fourth exemplary embodiment in FIG. 7, there is an asymmetric adjustment of the shifting hysteresis 4 in response to recognition of an acceleration as a current travel situation of the bicycle 100.

In this case, the shifting hysteresis 4 for the target upshifting point 31 is set to the value of zero so that the target upshifting point 31 corresponds to the reference shifting point 1.

At the same time, the shifting hysteresis 4 is maintained for the target downshifting point 32, or alternatively increased to, e.g., 15%. As a result, an optimal pedaling cadence, in particular close to the reference pedaling cadence 3, can always be regulated when accelerating the bicycle 100 across multiple gears by always shifting close to it. Thus, optimized riding comfort can also be provided for the rider of the bicycle 100 in this travel situation.

It should be noted that the exemplary embodiments described can be combined together in any desired manner. For example, any of the exemplary embodiments described can be provided for particular time periods and/or particular modes of operation of the bicycle 100.

What is claimed is:

1. A method for controlling a gear shifting mechanism of a bicycle, comprising:
ascertaining a reference shifting point;
ascertaining the current travel situation of the bicycle;
determining a shifting hysteresis based on the current travel situation ascertained; and
ascertaining a target shifting point by adjusting the reference shifting point by way of the shifting hysteresis determined.

2. The method according to claim 1, wherein the reference shifting point is ascertained such that, given a gear change at the reference shifting point, a change in pedaling cadence caused by the gear change is symmetrical to a reference pedaling cadence.

3. The method according to claim 2, wherein:
in a first travel situation, a reduction of the shifting hysteresis is performed in order to reduce a deviation of an actual pedaling cadence from the reference pedaling cadence, and/or
in a second travel situation, an increase of the shifting hysteresis is performed in order to reduce the number of gear changes.

4. The method according to claim 1, wherein a target upshifting point and a target downshifting point are ascertained for each reference shifting point, respectively, by adjusting the reference shifting point by way of the shifting hysteresis.

5. The method according to claim 4, wherein:
the target downshifting point at lower speeds is compared to the reference shifting point, and/or
the target upshifting point at higher speeds is compared to the reference shifting point.

6. The method according to claim 4, wherein the shifting hysteresis is the same or different for each reference switching point compared to the respective target downshifting point and the target upshifting point.

7. The method according to claim 1, further comprising:
ascertaining a constant rate of travel as the current travel situation; and
decreasing the shifting hysteresis in response to the ascertainment of the constant rate of travel.

8. The method according to claim 1, further comprising:
ascertaining a pedaling pause as the current travel situation; and
increasing the shifting hysteresis in response to the ascertainment the pedaling pause.

9. The method according to claim 1, further comprising:
ascertaining an ascent as the current travel situation; and
increasing the shifting hysteresis in response to the ascertainment of the ascent.

10. The method according to claim 4, further comprising:
ascertaining an acceleration as the current travel situation; and
decreasing the shifting hysteresis for the target upshifting point to the value of zero.

11. The method according to claim 1, wherein the ascertainment of the current travel situation of the bicycle is performed by way of sensor data from a sensor of the bicycle which comprises one or more of the following sensor data: slope, acceleration, speed, pedal torque, and pedaling cadence.

12. The method according to claim 1, further comprising:
ascertaining a shifting speed at the target shifting point based on a gear ratio of the bicycle;
sensing a speed; and
actuating a gear change when the sensed speed reaches the shifting speed.

13. The method according to claim 1, wherein:
the gear shifting mechanism of the bicycle comprises multiple gear steps, and
a separate target shifting point is ascertained for each gear change between all of the gear steps.

14. A shifting system of a bicycle, comprising:
a gear shifting mechanism; and
a control unit configured to operate the gear shifting mechanism,
wherein the control unit is configured to perform the method according to claim 1.

15. An electric bicycle, comprising the gear shifting system according to claim 14.

16. The method according to claim 4, further comprising:
ascertaining an acceleration as the current travel situation; and
decreasing the shifting hysteresis for the target upshifting point.

17. The method according to claim 1, wherein the ascertainment of the current travel situation of the bicycle is performed by way of sensor data from a sensor of the bicycle.
